(19) United States
(12) Patent Application Publication
(10) Pub. No.: US 2005/0206578 A1
(43) Pub. Date: Sep. 22, 2005

(54) Dual band antenna

(76) Inventors: Byung-Hoon Ryou, Kyonggi-do (KR); Weon-Mo Sung, Kwangju-city (KR); Myo-Geun Yang, Incheon-city (KR)

Correspondence Address: DELLETT AND WALTERS, P. O. BOX 2786, PORTLAND, OR, 97208-2786, US

(21) Appl. No.: 10/509,445

(22) PCT Filed: Apr. 2, 2003
(86) PCT No.: PCT/KR03/00662

§ 371 Date: Sep. 27, 2004

(30) Foreign Application Priority Data
Apr. 4, 2002 (KR) 10-2002-0018664
Apr. 17, 2002 (KR) 10-2002-0020992

(51) Int. Cl. H01Q 1/36

(52) U.S. Cl. 343/895

(57) ABSTRACT

The present invention relates generally to a dual band antenna, and more particularly to a dual band antenna, in which a hollow or solid parasitic element is disposed inside an antenna formed by winding a wire material several times or bending a strip material several times to have a predetermined shape. The dual band antenna of the present invention can be easily manufactured, and can improve the efficiency thereof and meet a desired bandwidth by overcoming the problem of connecting dielectric materials to helical parts of different pitches to fix the dielectric materials in the prior art, improving the variation of performance resulting from manufacturing variation and designing the dual band antenna to have a maximal size with respect to the shape thereof, thus immediately meeting the movement of a central frequency caused by the various environments of the antenna.

### TECHNICAL FIELD

The present invention relates generally to a dual band antenna, and more particularly to a dual band antenna, in which a hollow or solid parasitic element is disposed inside an antenna formed by winding a wire material several times or bending a strip material several times to have a predetermined shape, thus allowing the same resonance frequency band to be employed without variation.

### BACKGROUND ART

In a general feeding structure of a conventional small-sized antenna used in wireless communications, antenna feed is performed through contact using a conductive object on a board, or a coaxial cable. For monopole antennas, antenna feed is performed through a + part contact using a conductive mechanical part, or simultaneous antenna feed is performed through + and − parts of a coaxial cable. For dipole antennas, simultaneous antenna feed is performed through + and − parts of a coaxial cable.

FIG. 1 is an exemplary view showing a structure of a conventional dual band antenna 100, which may be divided into a first helical part 110 to have a narrow pitch and a second helical part 120 situated below the first helical part 110 to have a wide pitch, and in which the first and second helical parts 110 and 120 are integrated together.

The conventional dual band antenna 100 formed by integrating two kinds of helical parts having different winding pitches is used to adjust frequencies in such a way that the first and second helical parts 110 and 120 are used together as a single antenna when a lower frequency band is utilized, and the first helical part 110 servers to perform matching and the second helical part 120 performs higher frequency resonance by adjusting the pitch thereof when a higher frequency band is utilized.

In the conventional dual band antenna having the above-described structure, the higher frequency resonance sensitively varies depending upon pitches, so the precise formation of different pitches and the fixation of different pitch helical parts onto different dielectric materials are required, and the formation of circular helical parts is essentially needed. Further, a space cannot be ensured to meet a need for the various shapes of antennas. Further, dielectric materials of different pitches should be separately connected to the helical parts to be fixedly disposed due to the structure of the dual pitch helical structure of the conventional dual band antenna, the efficiency of the conventional dual band antenna is deteriorated due to the non-uniform characteristics of manufactured antennas, and the conventional dual band antenna is not suitable for mass production due to the large variation of performance resulting from manufacturing deviation thereof. Additionally, since in the conventional dual band antenna a bandwidth is formed to be narrow as shown in FIG. 2, the conventional dual band antenna is problematic in that it is insufficient to actively meet the movement of a central frequency, thus being insufficient to meet the variation of the environments of a mobile terminal.

### DISCLOSURE OF THE INVENTION

Accordingly, the present invention has been made keeping in mind the above problems occurring in the prior art, and an object of the present invention is to provide a dual band antenna, which can be easily manufactured, and can improve the efficiency thereof and meet a desired bandwidth by overcoming the problem of connecting dielectric materials to helical parts of different pitches to fix the dielectric materials in the prior art, improving the variation of performance resulting from manufacturing variation and designing the dual band antenna to have a maximal size with respect to the shape thereof, thus immediately meeting the movement of a central frequency caused by the various environments of the antenna.

Another object of the present invention is to provide a dual band antenna, which allows the same frequency band to be employed without variation regardless of the height of frequency resonance.

In order to accomplish the above object, the present invention provides a dual band antenna, wherein a hollow or solid parasitic element is disposed in an inner space of a first member formed by winding a wire material several times or bending a strip material several times to form a predetermined shape and a dielectric material is disposed between the first member and the parasitic element, thus generating dual resonance by inducing variation of impedance resulting from coupling.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exemplary view showing a structure of a conventional dual band antenna;

FIG. 2 is a Voltage Standing Wave Ratio (VSWR) graph showing the electrical characteristics of the conventional dual band antenna;

FIG. 3 is an exemplary view showing a structure of a dual band antenna to which the technology of the present invention is applied;

FIG. 4 is an equivalent circuit when a dual band is formed by the dual band antenna of the present invention;

FIG. 5 is a VSWR graph showing the electrical characteristics of the dual band antenna to which the technology of the present invention is applied; and

FIG. 6 is an exemplary view showing another structure of the dual band antenna to which the technology of the present invention is applied.

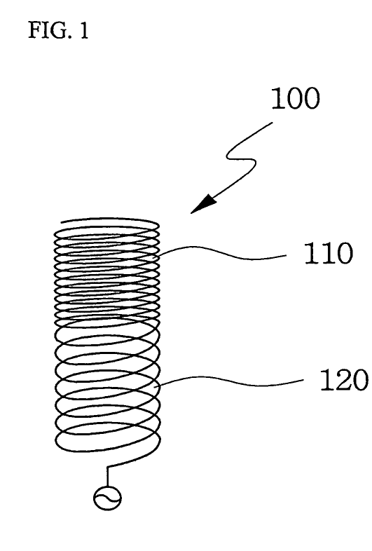

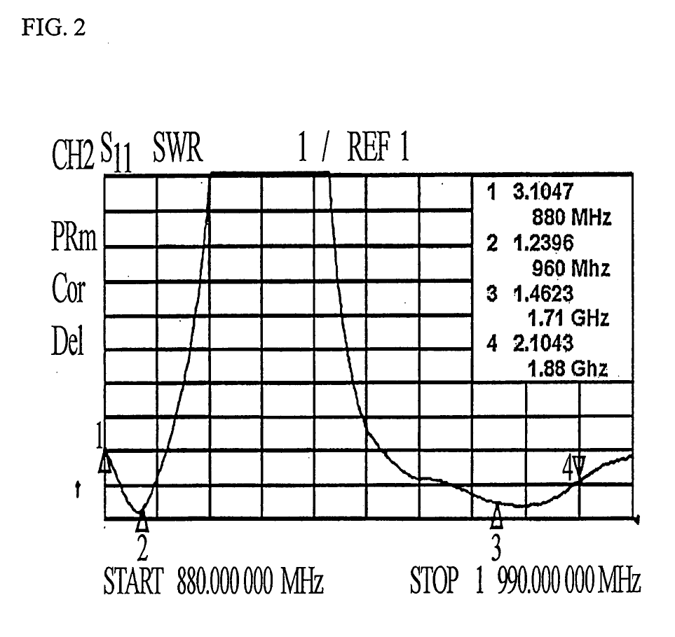

### BEST MODE FOR CARRYING OUT THE INVENTION

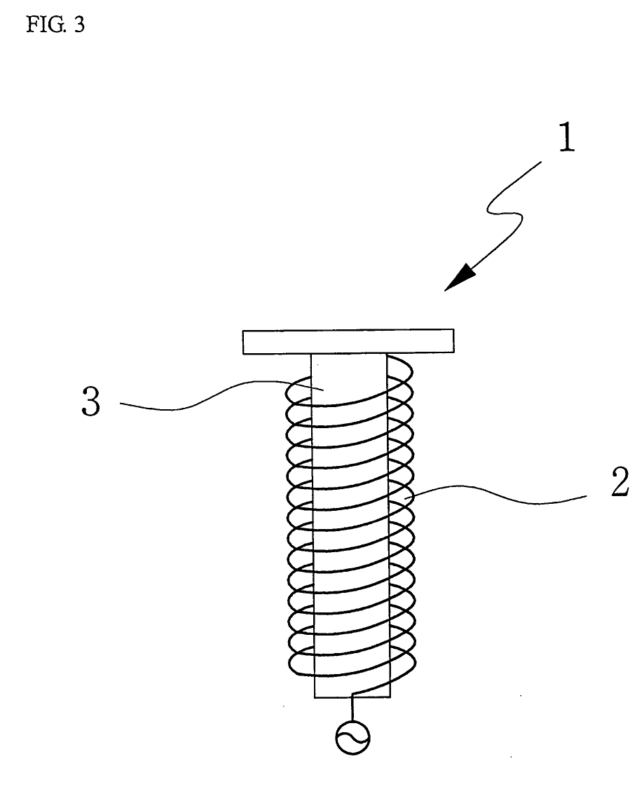

Preferred embodiments of the present invention will be described in detail with reference to the attached drawings below. FIG. 3 is an exemplary view showing a structure of a dual band antenna to which the technology of the present invention is applied in accordance with a preferred embodiment. Referring to this drawing, a dual band antenna 1 to which the present invention is applied has a mechanically separated and electrically coupled structure in which a hollow or solid parasitic element is disposed in an inner space of a first member 2 formed by winding a wire material, such as a metallic wire, several times and a dielectric material is disposed between the parasitic element 3 and the first member 2.

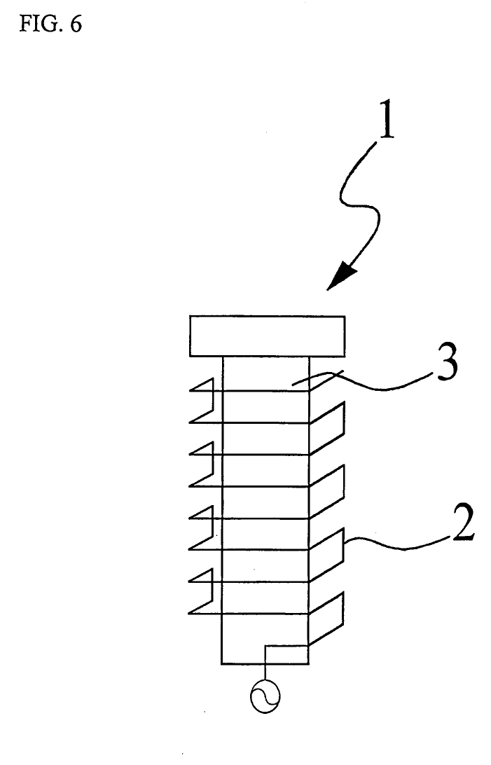

Meanwhile, FIG. 6 is an exemplary view showing another embodiment of the present invention, in which a dual band antenna 1 has a mechanically separated and electrically coupled structure in which a hollow or solid parasitic element is disposed in an inner space of a first member 2 formed by bending a strip material to have a predetermined shape and a dielectric material is disposed between the parasitic element 3 and the first member 2.

The first member 2 forms a circular shape in the plan view thereof as shown in FIG. 3, forms a rectangular shape with one side thereof open as shown in FIG. 6, and may be bent in a triangular shape although not shown in the drawings.

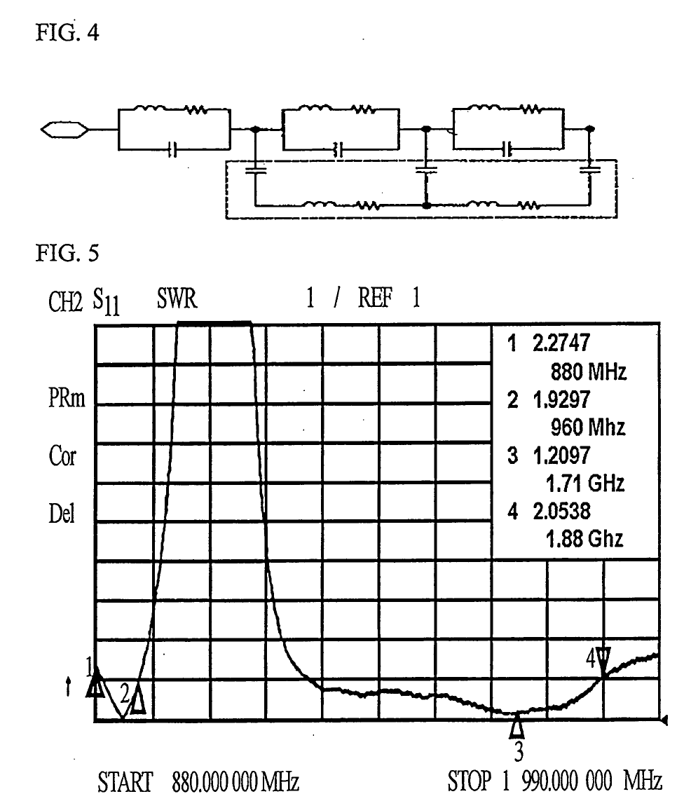

The operation and effect of the present invention having the above-descried structure, as shown in FIGS. 4 and 5, allow C to be low at a lower frequency and to be high at a higher frequency through the insertion of the parasitic element, which is equivalent to a parallel structure having lower R and L and higher C, into parallel resonance, thus forming corresponding resonance frequencies and achieving dual resonance. Additionally, this means that a bandwidth can be widened by compensating for the increase of Q value resulting from the resonance of a neighboring frequency using the series resonance of the C and L of the parasitic element.

A frequency is adjusted by forming dual resonance by inducing the variations of impedance resulting from coupling by inserting the parasitic element 3 in the inner space of the first member 2 or 2a having a predetermined shape.

The frequency can be adjusted by varying the thickness, length and shape of the parasitic element 3 to be inserted into the inside of the first member 2 or 2a having a predetermined shape. That is, the thickness of the parasitic element 3 can adjust the resonant width of the resonance frequency, the length of the parasitic element 3 can adjust the movement of the resonance frequency, and the shape of the parasitic element 3 can form triple resonance as well as dual resonance, that is, a multi-band.

Accordingly, the movement of a central frequency resulting from the various environments of the antenna is met by adjusting the thickness, length and shape of the parasitic element 3 to satisfy various frequencies.

### INDUSTRIAL APPLICABILITY

Accordingly, the dual band antenna achieved by the present invention can be easily manufactured, and can improve the efficiency thereof and meet a desired bandwidth by improving the variation of performance resulting from manufacturing variation, which is a problem of the conventional antenna, and designing the dual band antenna to have a maximal size for the shape thereof, thus immediately meeting the movement of a central frequency caused by the various environments of the antenna.

1. A dual band antenna, wherein a hollow or solid parasitic element is disposed in an inner space of a first member formed by winding a wire material several times or bending a strip material several times to form a predetermined shape and a dielectric material is disposed between the first member and the parasitic element, thus enabling generation of dual resonance of the same frequency band regardless of height of resonance frequencies by inducing variation of impedance resulting from coupling.

2. The dual band antenna as set forth in claim 1, wherein the first member forms a circular shape, or rectangular shape with one side thereof open in a plan view thereof.

3. The dual band antenna as set forth in claim 1, wherein a width of each of the resonance frequencies is adjusted by adjusting a thickness of the parasitic element.

4. The dual band antenna as set forth in claim 1, wherein movement of each of the resonance frequencies is adjusted by adjusting a length of the parasitic element.

5. The dual band antenna as set forth in claim 1, wherein triple resonance as well as dual resonance is formed by adjusting a shape of the parasitic element.
